(19) United States
(12) Patent Application Publication
(10) Pub. No.: US 2026/0315954 A1
(43) Pub. Date: Oct. 15, 2026

(54) ENERGY EFFICIENT MULTIPLE-EFFECT EVAPORATION SYSTEM

(71) Applicant: SABIC GLOBAL TECHNOLOGIES B.V., Bergen op Zoom (NL)

(72) Inventors: Muhammad Imran YAQUB, Jubail (SA); Jai Prakash JAIN, Jubail (SA); Khaled Atiyah AL-GHAMDI, Jubail (SA)

(21) Appl. No.: 19/483,839

(22) PCT Filed: May 13, 2024
(86) PCT No.: PCT/EP2024/063058

§ 371 Date: Nov. 12, 2025

(30) Foreign Application Priority Data
May 19, 2023 (EP) 23174267.7

(51) Int. Cl. B01D 1/28; B01D 1/26; C02F 1/04; C02F 101/34; C02F 103/36

(52) U.S. Cl. CPC B01D 1/2846; B01D 1/26; C02F 1/041; C02F 2101/34; C02F 2103/36; C02F 2301/08; C02F 2303/10

(57) ABSTRACT

A multiple-effect evaporation system includes a first evaporator in fluid communication with a reboiler for heating and recirculating fluid, the reboiler receiving heat from an external heat source; and a series of two or more additional evaporators downstream from the first evaporator, each of the evaporators producing an overhead vapor effluent and a liquid bottom effluent and each additional evaporator having a reboiler in fluid communication with the overhead vapor effluent of the previous evaporator in series as heat source for the reboiler. The system further includes a compressor in fluid communication with a portion of overhead vapor effluent of one of the two or more additional evaporators, wherein effluent from the compressor is in fluid communication with the overhead vapor effluent of any upstream evaporator in the series.

### TECHNOLOGICAL FIELD

The present disclosure relates to multiple-effect evaporation systems and methods for operating such systems.

### BACKGROUND

Commercial processes for the preparation of alkylene glycols, such as ethylene glycol, propylene glycol and butylene glycol, typically involve the liquid phase hydration of the corresponding epoxide in the presence of a large molar excess of water. The hydrolysis reaction is typically conducted at moderate temperatures (e.g., 130 to 210° C.) with water being provided to the reaction zone in excess of 15 to 30 moles per mole of epoxide. The primary by-products of the hydrolysis reaction are di-, tri-, and higher glycols.

In one example process, ethylene glycol is produced from ethylene (ethene) via the intermediate ethylene oxide. Ethylene oxide reacts with water to produce ethylene glycol according to the chemical equation:

C₂H₄O+H₂O→HO—CH₂CH₂—OH

This reaction can be catalyzed by either acids or bases, or can occur at neutral pH under elevated temperatures. Conventionally, this is a non-catalytic reaction. The highest yields of ethylene glycol occur at acidic or neutral pH with a large excess of water. The major byproducts are oligomers such as diethylene glycol, triethylene glycol, and tetraethylene glycol.

Recovery of the glycols from the hydrolysis reaction mixture is an energy-intensive task due to the large excess of water. Typically, the water is removed by evaporation, leaving a glycol-containing residue that can be further purified by distillation. A multiple-effect evaporator is typically used for the evaporation process, wherein water is boiled in a sequence of vessels, each held at a lower pressure than the previous vessel. Since the boiling temperature of water decreases as pressure decreases, the vapor boiled off in one vessel can be used to heat the next, and only the first vessel (at the highest pressure) requires an external source of heat.

There remains a need in the art for improved systems and methods for separating water from glycol reaction mixtures, particularly improvements that reduce energy usage.

### BRIEF SUMMARY

The present disclosure provides a system and method for conducting multiple-effect evaporation with enhanced efficiency through compression and recycle of a portion of the overhead effluent from one of the evaporators in series to the overhead of an evaporator upstream in the series. Since the overhead of each evaporator is directed to the reboiler of the next evaporator in series, compression and recycle of the overhead vapor improves thermal efficiency of the reboilers. The improved thermal efficiency of the reboilers reduces the external energy required for the reboiler of the first evaporator in series, resulting in cost savings and reduced greenhouse emissions. The source of compressor power can be electricity from a renewable source to further reduce greenhouse emissions.

The present disclosure includes, without limitation, the following embodiments.

Embodiment 1: A multiple-effect evaporation system, comprising: a first evaporator positioned to receive a feed stream comprising predominantly water, the first evaporator in fluid communication with a first reboiler for heating and recirculating a fluid stream from the first evaporator, the first reboiler receiving heat from an external heat source, the first evaporator producing an overhead vapor effluent and a liquid bottom effluent; a series of two or more additional evaporators downstream from the first evaporator, each of said two or more additional evaporators producing an overhead vapor effluent and a liquid bottom effluent and having a reboiler for heating and recirculating a fluid stream to the additional evaporator, each reboiler in fluid communication with the overhead vapor effluent of the previous evaporator in series as heat source for the reboiler, and each of said two or more additional evaporators receiving a liquid bottom effluent from the previous evaporator in series as a feed stream; and a compressor in fluid communication with a portion of overhead vapor effluent of one of said two or more additional evaporators and adapted to increase the pressure of the portion of overhead vapor effluent, wherein the effluent from the compressor is in fluid communication with the overhead vapor effluent of any upstream evaporator in the multiple-effect evaporation system.

Embodiment 2: The multiple-effect evaporation system of Embodiment 1, comprising: a second evaporator in fluid communication with a second reboiler for heating and recirculating a fluid stream from the second evaporator, the second reboiler in fluid communication with the overhead vapor effluent of the first evaporator as heat source for the second reboiler, the second evaporator receiving the liquid bottom effluent of the first evaporator as a feed stream, the second evaporator producing an overhead vapor effluent and a liquid bottom effluent; a third evaporator in fluid communication with a third reboiler for heating and recirculating a fluid stream from the third evaporator, the third reboiler in fluid communication with the overhead vapor effluent of the second evaporator as heat source for the third reboiler, the third evaporator receiving the liquid bottom effluent of the second evaporator as a feed stream, the third evaporator producing an overhead vapor effluent and a liquid bottom effluent; and a fourth evaporator in fluid communication with a fourth reboiler for heating and recirculating a fluid stream from the fourth evaporator, the fourth reboiler in fluid communication with the overhead vapor effluent of the third evaporator as heat source for the fourth reboiler, the fourth evaporator receiving the liquid bottom effluent of the third evaporator as a feed stream, the fourth evaporator producing an overhead vapor effluent and a liquid bottom effluent, wherein the compressor is in fluid communication with a portion of overhead vapor effluent of either the third or fourth evaporator and adapted to increase the pressure of the portion of overhead vapor effluent, and wherein the effluent from the compressor is in fluid communication with the overhead vapor effluent of an upstream evaporator in the multiple-effect evaporation system selected from the first evaporator, the second evaporator, and the third evaporator.

Embodiment 3: The multiple-effect evaporation system of Embodiment 1 or 2, wherein the total number of evaporators in series is 4 to 8 (e.g., 4 to 6 or 4 to 7 or 4 to 8), and wherein: the compressor receives the portion of overhead vapor effluent from the third evaporator in series and the compressor effluent is in fluid communication with the overhead vapor effluent of the first evaporator; or the compressor receives the portion of overhead vapor effluent from the third evaporator in series and the compressor effluent is in fluid communication with the overhead vapor effluent of the second evaporator in series; or the compressor receives the portion of overhead vapor effluent from the fourth evaporator in series and the compressor effluent is in fluid communication with the overhead vapor effluent of the first evaporator; or the compressor receives the portion of overhead vapor effluent from the fourth evaporator in series and the compressor effluent is in fluid communication with the overhead vapor effluent of the second evaporator in series; or the compressor receives the portion of overhead vapor effluent from the fourth evaporator in series and the compressor effluent is in fluid communication with the overhead vapor effluent of the third evaporator in series; or the compressor receives the portion of overhead vapor effluent from a fifth evaporator in series and the compressor effluent is in fluid communication with the overhead vapor effluent of any one of the first through fourth evaporators in series; or the compressor receives the portion of overhead vapor effluent from a sixth evaporator in series and the compressor effluent is in fluid communication with the overhead vapor effluent of any one of the first through fifth evaporators in series; or the compressor receives the portion of overhead vapor effluent from a seventh evaporator in series and the compressor effluent is in fluid communication with the overhead vapor effluent of any one of the first through sixth evaporators in series.

Embodiment 4: The multiple-effect evaporation system of any one of Embodiments 1 to 3, wherein the ratio of the discharge pressure to the suction pressure of the compressor is about 1.2 to about 3, such as about 1.3 to about 2.8 or about 1.4 to about 2.6.

Embodiment 5: The multiple-effect evaporation system of any one of Embodiments 1 to 4, wherein the portion of overhead vapor effluent received by the compressor is about 30 to about 60% by weight of the total overhead vapor effluent.

Embodiment 6: The multiple-effect evaporation system of any one of Embodiments 1 to 5, wherein the system operates in thermosiphon mode such that a pressure differential between each evaporator drives fluid transfer between evaporators, and optionally wherein the external heat source is steam, and optionally wherein the compressor is powered by renewable electricity.

Embodiment 7: The multiple-effect evaporation system of any one of Embodiments 1 to 6, wherein each evaporator receives a reflux water feed stream proximal to the top of the evaporator.

Embodiment 8: The multiple-effect evaporation system of any one of Embodiments 1 to 7, wherein the feed stream to the first evaporator comprises water and an alkylene glycol, such as ethylene glycol, and optionally wherein the feed stream to the first evaporator comprises 85% by weight or more of water, such as 90% by weight or more of water, and optionally wherein the feed stream to the first evaporator has a pressure of about 20 barg or higher, and optionally wherein the overhead vapor effluent of the first evaporator has a pressure of 10 barg or higher, such as a pressure of 12 barg or higher, or about 15 barg or higher, or about 20 barg or higher.

Embodiment 9: A method for operating a multiple-effect evaporation system, comprising: introducing a feed stream comprising predominantly water to a first evaporator, the first evaporator in fluid communication with a first reboiler for heating and recirculating a fluid stream from the first evaporator, the first reboiler receiving heat from an external heat source, wherein the first evaporator produces an overhead vapor effluent and a liquid bottom effluent; introducing the liquid bottom effluent from the first evaporator as a feed stream to a second evaporator, the second evaporator in fluid communication with a second reboiler for heating and recirculating a fluid stream from the second evaporator, wherein the second evaporator produces an overhead vapor effluent and a liquid bottom effluent; passing the overhead vapor effluent from the first evaporator to the second reboiler as heat source for the second reboiler; introducing the liquid bottom effluent from the second evaporator as a feed stream to a third evaporator, the third evaporator in fluid communication with a third reboiler for heating and recirculating a fluid stream from the third evaporator, wherein the third evaporator produces an overhead vapor effluent and a liquid bottom effluent; passing the overhead vapor effluent from the second evaporator to the third reboiler as heat source for the third reboiler; optionally, introducing the liquid bottom effluent from the third evaporator as a feed stream to one or more additional evaporators positioned in series downstream from the third evaporator, each of the additional evaporators producing an overhead vapor effluent and a liquid bottom effluent and having a reboiler for heating and recirculating a fluid stream to the additional evaporator, each reboiler in fluid communication with the overhead vapor effluent of the previous evaporator in series as heat source for the reboiler, and each of the additional evaporators receiving a liquid bottom effluent from the previous evaporator in series as a feed stream; introducing a portion of overhead vapor effluent of the third evaporator or one of the downstream additional evaporators to a compressor to increase the pressure of the portion of overhead vapor effluent; and mixing the effluent from the compressor with the overhead vapor effluent of any evaporator upstream of the evaporator producing the portion of overhead vapor effluent.

Embodiment 10: The method of Embodiment 9, comprising: introducing the liquid bottom effluent from the third evaporator as a feed stream to a fourth evaporator, the fourth evaporator in fluid communication with a fourth reboiler for heating and recirculating a fluid stream from the fourth evaporator, wherein the fourth evaporator produces an overhead vapor effluent and a liquid bottom effluent; and passing the overhead vapor effluent from the third evaporator to the fourth reboiler as heat source for the fourth reboiler; wherein the compressor is in fluid communication with a portion of overhead vapor effluent of either the third or fourth evaporator and adapted to increase the pressure of the portion of overhead vapor effluent, and wherein the effluent from the compressor is mixed with the overhead vapor effluent of an upstream evaporator in the multiple-effect evaporation system selected from the first evaporator, the second evaporator, and the third evaporator.

Embodiment 11: The method of Embodiment 9 or 10, wherein the total number of evaporators in series is 4 to 8 (e.g., 4 to 6 or 4 to 7 or 4 to 8), and wherein the compressor receives the portion of overhead vapor effluent from the third evaporator in series and the compressor effluent is mixed with the overhead vapor effluent of the first evaporator; or the compressor receives the portion of overhead vapor effluent from the third evaporator in series and the compressor effluent is mixed with the overhead vapor effluent of the second evaporator; or the compressor receives the portion of overhead vapor effluent from a fourth evaporator in series and the compressor effluent is mixed with the overhead vapor effluent of the first evaporator; or the compressor receives the portion of overhead vapor effluent from a fourth evaporator in series and the compressor effluent is mixed with the overhead vapor effluent of the second evaporator; or the compressor receives the portion of overhead vapor effluent from the fourth evaporator in series and the compressor effluent is mixed with the overhead vapor effluent of the third evaporator; or the compressor receives the portion of overhead vapor effluent from a fifth evaporator in series and the compressor effluent is mixed with the overhead vapor effluent of any one of the first through fourth evaporators in series; or the compressor receives the portion of overhead vapor effluent from a sixth evaporator in series and the compressor effluent is mixed with the overhead vapor effluent of any one of the first through fifth evaporators in series; or the compressor receives the portion of overhead vapor effluent from a seventh evaporator in series and the compressor effluent is mixed with the overhead vapor effluent of any one of the first through sixth evaporators in series.

Embodiment 12: The method of any one of Embodiments 9 to 11, wherein the ratio of the discharge pressure to the suction pressure of the compressor is about 1.2 to about 3, such as about 1.3 to about 2.8 or about 1.4 to about 2.6, and optionally wherein the portion of overhead vapor effluent received by the compressor is about 30 to about 60% by weight of the total overhead vapor effluent.

Embodiment 13: The method of any one of Embodiments 9 to 12, wherein the system operates in thermosiphon mode such that a pressure differential between each evaporator drives fluid transfer between evaporators, and optionally wherein the external heat source is steam, and optionally wherein the compressor is powered by renewable electricity.

Embodiment 14: The method of any one of Embodiments 9 to 13, further comprising introducing a reflux water feed stream to each evaporator.

Embodiment 15: The method of any one of Embodiments 9 to 14, wherein the feed stream to the first evaporator comprises water and an alkylene glycol, such as ethylene glycol, and optionally wherein the feed stream to the first evaporator comprises 85% by weight or more of water, such as 90% by weight or more of water, and optionally wherein the feed stream to the first evaporator has a pressure of about 20 barg or higher, and optionally wherein the overhead vapor effluent of the first evaporator has a pressure of 10 barg or higher, such as a pressure of 12 barg or higher, or about 15 barg or higher, or about 20 barg or higher.

These and other features, aspects, and advantages of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as combinable, unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying figures which illustrate, by way of example, the principles of some described example implementations.

### BRIEF DESCRIPTION OF THE FIGURE

Having thus described aspects of the disclosure in the foregoing general terms, reference will now be made to the accompanying figures, which is not necessarily drawn to scale, and wherein:

FIG. 1 is a simplified schematic diagram of an example multiple-effect evaporation system in accordance with the present disclosure;

FIG. 2 is a simplified schematic diagram of another example of a multiple-effect evaporation system in accordance with the present disclosure; and

FIG. 3 graphically illustrates a comparison of steam saving percentages to compressor power consumption as a function of flow through the compressor in accordance with one embodiment of the present disclosure.

### DETAILED DESCRIPTION

Some implementations of the present disclosure will now be described more fully hereinafter with reference to the accompanying figures, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Like reference numerals refer to like elements throughout.

Unless specified otherwise or clear from context, references to first, second or the like should not be construed to imply a particular order. A feature described as being above another feature (unless specified otherwise or clear from context) may instead be below, and vice versa; and similarly, features described as being to the left of another feature else may instead be to the right, and vice versa. Also, while reference may be made herein to quantitative measures, values, geometric relationships or the like, unless otherwise stated, any one or more if not all of these may be absolute or approximate to account for acceptable variations that may occur, such as those due to engineering tolerances or the like. As used in the specification and the appended claims, the singular forms “a,” “an,” and “the” include plural referents unless the context clearly dictates otherwise. As used in the specification and in the claims, the term “comprising” can include the aspects “consisting of” and “consisting essentially of” Unless defined otherwise, all technical and scientific terms used herein have the same meaning as commonly understood by one of ordinary skill in the art to which this invention belongs.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.).

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art.

As used herein, unless specified otherwise or clear from context, the “or” of a set of operands is the “inclusive or” and thereby true if and only if one or more of the operands is true, as opposed to the “exclusive or” which is false when all of the operands are true. Thus, for example, “[A] or [B]” is true if [A] is true, or if [B] is true, or if both [A] and [B] are true.

The present disclosure relates to improved operation of a multiple-effect evaporation system. As explained above, a multiple-effect evaporator is an energy-intensive process for separating a desired product from a large excess of water. One example of such a product is an alkylene glycol, such as ethylene glycol, which is typically made in a process involving large amounts of water. However, the multiple-effect evaporation system of the present disclosure could be used to separate other products from water without departing from the invention.

In the present disclosure, at least a portion of the overhead vapor stream from one of a series of evaporators is compressed and recycled for mixing with the overhead vapor stream of an upstream evaporator in the system. As each evaporator in series (other than the first evaporator) receives heat energy in its reboiler from the overhead stream of the previous evaporator in series, the compression and recycle of an overhead stream can improve thermal efficiency of the evaporation process. This leads to a reduction in the heat energy required for the reboiler of the first evaporator in series, which must be provided from an external source, such as a steam source.

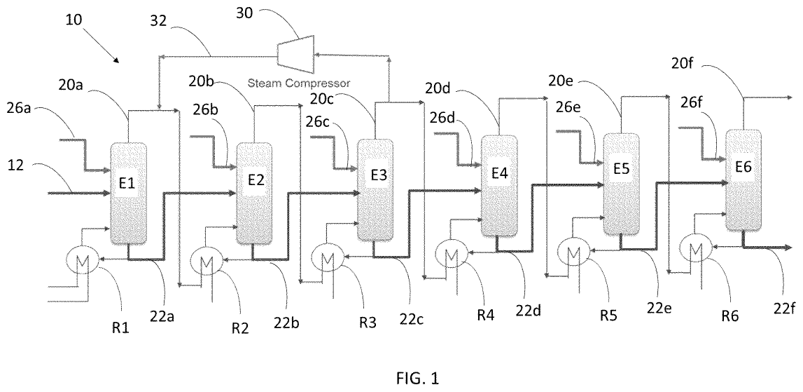

An example embodiment of a multiple-effect evaporation system 10 is set forth in FIG. 1. As shown, the system 10 includes a series of six evaporators in series, E1 through E6. However, the system 10 can include a different number of evaporators without departing from the present invention, such as 4 to 8 evaporators (e.g., 4, 5, 6, 7, or 8 evaporators in series). The first evaporator, E1, receives the feed stream 12 requiring purification through water removal. Each evaporator vessel can be any of the types of known evaporators in the art, such as rising or falling film evaporators, forced circulation evaporators, and the like.

As noted above, the feed stream 12 to the first evaporator E1 can be any liquid stream comprising predominantly water (e.g., greater than 50% by weight water) and containing a product that needs to be separated from water. In certain embodiments, the feed stream 12 comprises 85% by weight or more of water, such as 90% by weight or more of water, based on the total weight of the feed. An example product requiring separation from water is an alkylene glycol, such as ethylene glycol, propylene glycol, or butylene glycol. In certain embodiments, the feed stream 12 includes 10-15% by weight or less of alkylene glycol (e.g., 1 to 10% by weight), based on total weight of the feed. Each evaporator, E1-E6, can also receive a water feed, 26a-26f, to serve as reflux, typically introduced proximal to the top or overhead of the column, to reduce the amount of water entrained in the overhead stream of each evaporator.

Each evaporator, E1 through E6, includes a reboiler, R1 through R6, respectively, which is part of a fluid recirculation system for each evaporator. Each reboiler serves to vaporize a portion of the bottoms stream from the evaporator and return the vapor to the evaporator. As shown, only the first reboiler, R1, receives heat from an external source, such as an external steam source. The remaining reboilers receive the overhead vapor effluent, 20a-20e, from the previous evaporator in series as the source of heat energy. Each reboiler is typically designed to completely condense the steam fed to the reboiler. The final overhead vapor effluent 20f, as well as a portion of the overhead vapor effluent from earlier evaporator stages (e.g., 20e) can be used as a source of steam elsewhere in the plant, such as use as process steam in various other portions of the process including extraction steam in reboilers or as steam inputs for various columns (not shown).

The liquid bottom effluent, 22a-22e, of each evaporator in series serves as the liquid feed for the next evaporator in series. The liquid bottom effluent 22f from the final evaporator E6 in series is the purified product stream having greatly reduced water content. In certain embodiments, the final liquid bottom effluent 22f includes 85% by weight or more of alkylene glycol (e.g., 85 to 90% by weight), based on total weight of the effluent. The condensate from each reboiler can be collected and used, for example, to adjust the water to alkylene glycol ratio of feed stream 12 (not shown).

The multiple-effect evaporation system further includes a compressor in fluid communication with a portion of overhead vapor effluent of one of the evaporators and adapted to increase the pressure of the portion of overhead vapor effluent. The effluent form the compressor is in fluid communication with the overhead vapor effluent of any upstream evaporator in the multiple-effect evaporation system.

The steam compressor can be any steam compressor known in the art, including both single and multi-stage compressors. Example compressor types include Roots steam compressors and centrifugal steam compressors. The ratio of the discharge pressure to the suction pressure of the compressor can vary, with example ranges including about 1.2 to about 3, such as about 1.3 to about 2.8 or about 1.4 to about 2.6. The portion of overhead vapor effluent received by the compressor can also vary, with an example range of about 30 to about 60% by weight of the total overhead vapor effluent.

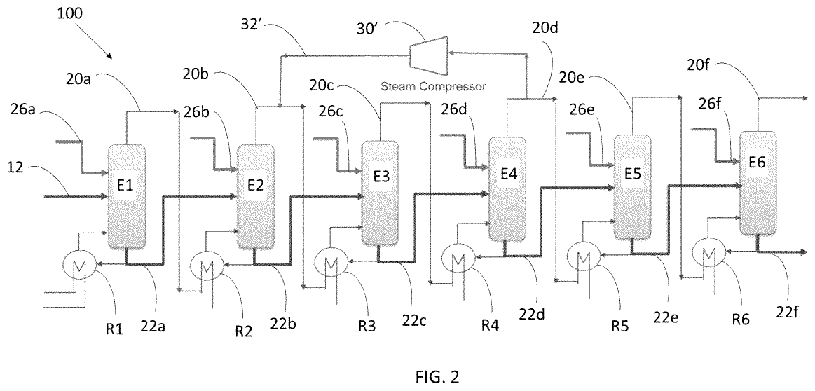

The placement of the compressor within the multiple-effect evaporation system can vary. In the embodiment of FIG. 1, the compressor 30 receives a portion of the overhead vapor effluent 20c leaving the third evaporator E3. The effluent 32 from compressor 30 is mixed with the overhead vapor effluent 20a leaving the first evaporator E1. However, both the evaporator from which the compressor 30 draws a portion of the overhead stream and the evaporator to which the compressed vapor is delivered may vary. For example, FIG. 2 illustrates a different embodiment of a multiple-effect evaporation system 100 wherein compressor 30′ receives a portion of the overhead vapor effluent 20d from the fourth evaporator E4 and delivers a compressed vapor stream 32′ to the overhead vapor effluent 20b of the second evaporator E2. Neither the embodiment of FIG. 1 nor the embodiment of FIG. 2 are limiting, but rather serve as examples of different evaporator combinations.

In certain embodiments of the disclosure, the multiple-effect evaporation system will have 4 to 8 evaporators in series, and example combinations of originating and destination overhead vapor streams include wherein (1) the compressor receives the portion of overhead vapor effluent from the third evaporator in series and the compressor effluent is in fluid communication with the overhead vapor effluent of the first or second evaporator in the series; (2) the compressor receives the portion of overhead vapor effluent from the fourth evaporator in series and the compressor effluent is in fluid communication with the overhead vapor effluent of the first, second, or third evaporator in the series; (3) the compressor receives the portion of overhead vapor effluent from a fifth evaporator in series and the compressor effluent is in fluid communication with the overhead vapor effluent of any one of the first through fourth evaporators in series; (4) the compressor receives the portion of overhead vapor effluent from a sixth evaporator in series and the compressor effluent is in fluid communication with the overhead vapor effluent of any one of the first through fifth evaporators in series; or (5) the compressor receives the portion of overhead vapor effluent from a seventh evaporator in series and the compressor effluent is in fluid communication with the overhead vapor effluent of any one of the first through sixth evaporators in series.

In certain embodiments, there will be at least one evaporator between the originating and destination evaporator, meaning at least one evaporator is positioned between the evaporator from which overhead effluent is sourced for the compressor and the evaporator to which the compressor effluent is sent. As shown in the Experimental, greater steam savings can be achieved in such embodiments. In addition, in certain embodiments, the ratio of the discharge pressure to the suction pressure of the compressor will be relatively high, which is again shown in the Experimental to lead to greater steam savings. In certain embodiments, this ratio is greater than 1.8, or greater than 2.0, or greater than 2.2, or greater than 2.4, with example ranges including 1.8 to 3.0 or 2.0 to 2.8.

The multiple-effect evaporation system operates in thermosiphon mode such that a pressure differential between each evaporator drives fluid transfer between evaporators. In certain embodiments, the feed stream to the first evaporator has a pressure of about 20 barg or higher (e.g., about 20 to about 30 barg). The operating pressure of each evaporator is lower than the previous evaporator in the series. For example, the first evaporator in the series can have an overhead vapor effluent at a pressure of 10 barg or higher, such as a pressure of 12 barg or higher, or about 15 barg or higher, or about 20 barg or higher (e.g., about 10 to about 25 barg or about 12 to about 20 barg). An example overhead pressure range for a fourth evaporator in series is about 3 barg or higher, such as about 4 barg or higher, or about 5 barg or higher (e.g., about 3 to about 8 barg or about 4 to about 6 barg). The final evaporator in the series is typically operated at vacuum pressure such that the overhead vapor stream leaving the final evaporator is, for example, about 0.8 barg or less, or about 0.6 barg or less, or about 0.4 barg or less (e.g., about 0.1 to about 0.8 barg).

As explained above, by compressing and recycling a portion of the overhead vapor stream from one of the downstream evaporators, greater heat transfer efficiency within the reboilers of the series can be achieved. This reduces the amount of external heat (e.g., steam) required for the evaporation process, which reduces cost and greenhouse gas emissions. Still further, by powering the compressor with renewable electricity, meaning electricity generated using a renewable power source such as wind or solar power, further reductions in carbon footprint can be achieved.

The disclosure may additionally, or alternatively, be formulated so as to be devoid, or substantially free, of any components, materials, ingredients, adjuvants or species used in the prior art compositions or that are otherwise not necessary to the achievement of the function and/or objectives of the present disclosure. Many modifications and other implementations of the disclosure will come to mind to one skilled in the art to which this disclosure pertains having the benefit of the teachings presented in the foregoing descriptions and the associated figures. Therefore, it is to be understood that the disclosure is not to be limited to the specific implementations disclosed herein and that modifications and other implementations are intended to be included within the scope of the appended claims. Although specific terms are employed herein, they are used in a generic and descriptive sense only and not for purposes of limitation.

### EXPERIMENTAL

An Aspen based simulation model was built with the vapor compression system described herein integrated with a multiple-effect evaporator system comprising a series of six evaporators to evaluate energy savings. The impact of recycle of a compressed portion of the overhead stream from various evaporators in the series was evaluated. The simulation varied both the originating and the destination evaporator in the series. The energy/steam savings for each option along with energy CO₂ emissions reductions are reported in Table 1 below. Steam flow through compressor was considered to be 60-80 tons per hour.

TABLE 1

| | | CO₂ | Compres- |
|---|---|---|---|
| | | emission | sion ratio |
| | | reduction | (discharge |
| | Steam | (kilo- | pressure/ |
| | saving | metric | suction |
| | (%) | tons/year) | pressure) |
| Compression from | 17.1 | 33.6 | 1.7 |
| 3^{rd} stage overhead | | | |
| to 1^{st} stage | | | |
| overhead | | | |
| Compression from | 10.1 | 20.0 | 1.4 |
| 3^{rd} stage overhead | | | |
| to 2^{nd} stage | | | |
| overhead | | | |
| Compression from | 29.9 | 58.4 | 2.6 |
| 4^{th} stage overhead | | | |
| to 1^{st} stage | | | |
| overhead | | | |
| Compression from | 20.1 | 39.2 | 2.1 |
| 4^{th} stage overhead | | | |
| to 2^{nd} stage | | | |
| overhead | | | |
| Compression from | 11.3 | 22.4 | 1.5 |
| 4^{th} stage overhead | | | |
| to 3^{rd} stage | | | |
| overhead | | | |

The highest percentage of steam savings resulted from recycle and compression of a portion of the 4^{th} stage overhead to the 1^{st} stage overhead. As shown in Table 1 above, greater steam savings occurred in cases where the recycle bypassed one or more evaporators, meaning at least one evaporator is between the originating evaporator and the destination evaporator. Additionally, a higher degree of compression (i.e., a higher compression ratio) results in greater steam savings.

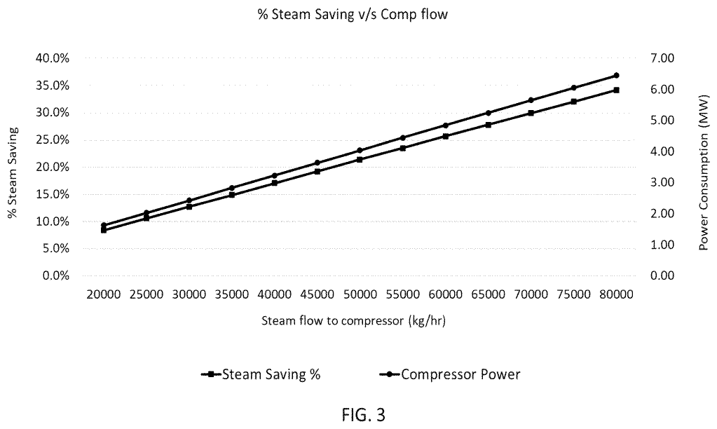

A sensitivity analysis was also conducted for the 4^{th} stage overhead to 1^{st} stage overhead embodiment, which compared steam saving percentages to compressor power consumption as a function of flow through the compressor. The results are set forth in FIG. 3. As shown, greater flow through the compressor leads to greater steam savings, but also greater power consumption by the compressor.

1. A multiple-effect evaporation system, comprising:
a first evaporator positioned to receive a feed stream comprising predominantly water, the first evaporator in fluid communication with a first reboiler for heating and recirculating a fluid stream from the first evaporator, the first reboiler receiving heat from an external heat source, the first evaporator producing an overhead vapor effluent and a liquid bottom effluent;
a series of two or more additional evaporators downstream from the first evaporator, each of said two or more additional evaporators producing an overhead vapor effluent and a liquid bottom effluent and having a reboiler for heating and recirculating a fluid stream to the additional evaporator, each reboiler in fluid communication with the overhead vapor effluent of the previous evaporator in series as heat source for the reboiler, and each of said two or more additional evaporators receiving a liquid bottom effluent from the previous evaporator in series as a feed stream; and
a compressor in fluid communication with a portion of overhead vapor effluent of one of said two or more additional evaporators and adapted to increase the pressure of the portion of overhead vapor effluent, wherein the effluent from the compressor is in fluid communication with the overhead vapor effluent of any upstream evaporator in the multiple-effect evaporation system.

2. The multiple-effect evaporation system of claim 1, comprising:
a second evaporator in fluid communication with a second reboiler for heating and recirculating a fluid stream from the second evaporator, the second reboiler in fluid communication with the overhead vapor effluent of the first evaporator as heat source for the second reboiler, the second evaporator receiving the liquid bottom effluent of the first evaporator as a feed stream, the second evaporator producing an overhead vapor effluent and a liquid bottom effluent;
a third evaporator in fluid communication with a third reboiler for heating and recirculating a fluid stream from the third evaporator, the third reboiler in fluid communication with the overhead vapor effluent of the second evaporator as heat source for the third reboiler, the third evaporator receiving the liquid bottom effluent of the second evaporator as a feed stream, the third evaporator producing an overhead vapor effluent and a liquid bottom effluent; and
a fourth evaporator in fluid communication with a fourth reboiler for heating and recirculating a fluid stream from the fourth evaporator, the fourth reboiler in fluid communication with the overhead vapor effluent of the third evaporator as heat source for the fourth reboiler, the fourth evaporator receiving the liquid bottom effluent of the third evaporator as a feed stream, the fourth evaporator producing an overhead vapor effluent and a liquid bottom effluent,
wherein the compressor is in fluid communication with a portion of overhead vapor effluent of either the third or fourth evaporator and adapted to increase the pressure of the portion of overhead vapor effluent, and wherein the effluent from the compressor is in fluid communication with the overhead vapor effluent of an upstream evaporator in the multiple-effect evaporation system selected from the first evaporator, the second evaporator, and the third evaporator.

3. The multiple-effect evaporation system of claim 1, wherein the total number of evaporators in series is 4 to 8, and wherein:
(a) the compressor receives the portion of overhead vapor effluent from the third evaporator in series and the compressor effluent is in fluid communication with the overhead vapor effluent of the first evaporator; or
(b) the compressor receives the portion of overhead vapor effluent from the third evaporator in series and the compressor effluent is in fluid communication with the overhead vapor effluent of the second evaporator in series; or
(c) the compressor receives the portion of overhead vapor effluent from the fourth evaporator in series and the compressor effluent is in fluid communication with the overhead vapor effluent of the first evaporator; or
(d) the compressor receives the portion of overhead vapor effluent from the fourth evaporator in series and the compressor effluent is in fluid communication with the overhead vapor effluent of the second evaporator in series; or
(e) the compressor receives the portion of overhead vapor effluent from the fourth evaporator in series and the compressor effluent is in fluid communication with the overhead vapor effluent of the third evaporator in series; or
(f) the compressor receives the portion of overhead vapor effluent from a fifth evaporator in series and the compressor effluent is in fluid communication with the overhead vapor effluent of any one of the first through fourth evaporators in series; or
(g) the compressor receives the portion of overhead vapor effluent from a sixth evaporator in series and the compressor effluent is in fluid communication with the overhead vapor effluent of any one of the first through fifth evaporators in series; or
(h) the compressor receives the portion of overhead vapor effluent from a seventh evaporator in series and the compressor effluent is in fluid communication with the overhead vapor effluent of any one of the first through sixth evaporators in series.

4. The multiple-effect evaporation system of claim 1, wherein the ratio of the discharge pressure to the suction pressure of the compressor is about 1.2 to about 3.

5. The multiple-effect evaporation system of claim 1, wherein the portion of overhead vapor effluent received by the compressor is about 30 to about 60% by weight of the total overhead vapor effluent.

6. The multiple-effect evaporation system of claim 1, wherein the system operates in thermosiphon mode such that a pressure differential between each evaporator drives fluid transfer between evaporators.

7. The multiple-effect evaporation system of claim 1, wherein each evaporator receives a reflux water feed stream proximal to the top of the evaporator.

8. The multiple-effect evaporation system of claim 1, wherein the feed stream to the first evaporator comprises water and an alkylene glycol.

9. A method for operating a multiple-effect evaporation system, comprising:
introducing a feed stream comprising predominantly water to a first evaporator, the first evaporator in fluid communication with a first reboiler for heating and recirculating a fluid stream from the first evaporator, the first reboiler receiving heat from an external heat source, wherein the first evaporator produces an overhead vapor effluent and a liquid bottom effluent;
introducing the liquid bottom effluent from the first evaporator as a feed stream to a second evaporator, the second evaporator in fluid communication with a second reboiler for heating and recirculating a fluid stream from the second evaporator, wherein the second evaporator produces an overhead vapor effluent and a liquid bottom effluent;
passing the overhead vapor effluent from the first evaporator to the second reboiler as heat source for the second reboiler;
introducing the liquid bottom effluent from the second evaporator as a feed stream to a third evaporator, the third evaporator in fluid communication with a third reboiler for heating and recirculating a fluid stream from the third evaporator, wherein the third evaporator produces an overhead vapor effluent and a liquid bottom effluent;
passing the overhead vapor effluent from the second evaporator to the third reboiler as heat source for the third reboiler;
optionally, introducing the liquid bottom effluent from the third evaporator as a feed stream to one or more additional evaporators positioned in series downstream from the third evaporator, each of the additional evaporators producing an overhead vapor effluent and a liquid bottom effluent and having a reboiler for heating and recirculating a fluid stream to the additional evaporator, each reboiler in fluid communication with the overhead vapor effluent of the previous evaporator in series as heat source for the reboiler, and each of the additional evaporators receiving a liquid bottom effluent from the previous evaporator in series as a feed stream;
introducing a portion of overhead vapor effluent of the third evaporator or one of the downstream additional evaporators to a compressor to increase the pressure of the portion of overhead vapor effluent; and
mixing the effluent from the compressor with the overhead vapor effluent of any evaporator upstream of the evaporator producing the portion of overhead vapor effluent.

10. The method of claim 9, comprising:
introducing the liquid bottom effluent from the third evaporator as a feed stream to a fourth evaporator, the fourth evaporator in fluid communication with a fourth reboiler for heating and recirculating a fluid stream from the fourth evaporator, wherein the fourth evaporator produces an overhead vapor effluent and a liquid bottom effluent; and
passing the overhead vapor effluent from the third evaporator to the fourth reboiler as heat source for the fourth reboiler;
wherein the compressor is in fluid communication with a portion of overhead vapor effluent of either the third or fourth evaporator and adapted to increase the pressure of the portion of overhead vapor effluent, and wherein the effluent from the compressor is mixed with the overhead vapor effluent of an upstream evaporator in the multiple-effect evaporation system selected from the first evaporator, the second evaporator, and the third evaporator.

11. The method of claim 9, wherein the total number of evaporators in series is 4 to 8, and wherein:
(a) the compressor receives the portion of overhead vapor effluent from the third evaporator in series and the compressor effluent is mixed with the overhead vapor effluent of the first evaporator; or
(b) the compressor receives the portion of overhead vapor effluent from the third evaporator in series and the compressor effluent is mixed with the overhead vapor effluent of the second evaporator; or
(c) the compressor receives the portion of overhead vapor effluent from a fourth evaporator in series and the compressor effluent is mixed with the overhead vapor effluent of the first evaporator; or
(d) the compressor receives the portion of overhead vapor effluent from a fourth evaporator in series and the compressor effluent is mixed with the overhead vapor effluent of the second evaporator; or
(e) the compressor receives the portion of overhead vapor effluent from the fourth evaporator in series and the compressor effluent is mixed with the overhead vapor effluent of the third evaporator; or
(f) the compressor receives the portion of overhead vapor effluent from a fifth evaporator in series and the compressor effluent is mixed with the overhead vapor effluent of any one of the first through fourth evaporators in series; or
(g) the compressor receives the portion of overhead vapor effluent from a sixth evaporator in series and the compressor effluent is mixed with the overhead vapor effluent of any one of the first through fifth evaporators in series; or
(h) the compressor receives the portion of overhead vapor effluent from a seventh evaporator in series and the compressor effluent is mixed with the overhead vapor effluent of any one of the first through sixth evaporators in series.

12. The method of claim 9, wherein the ratio of the discharge pressure to the suction pressure of the compressor is about 1.2 to about 3.

13. The method of claim 9, wherein the system operates in thermosiphon mode such that a pressure differential between each evaporator drives fluid transfer between evaporators.

14. The method of claim 9, further comprising introducing a reflux water feed stream to each evaporator.

15. The method of claim 9, wherein the feed stream to the first evaporator comprises water and an alkylene glycol.
